(19) United States
(12) Patent Application Publication
(10) Pub. No.: US 2021/0055994 A1
(43) Pub. Date: Feb. 25, 2021

(54) STORAGE SYSTEM WITH DATA RELIABILITY MECHANISM AND METHOD OF OPERATION THEREOF

(71) Applicant: CNEX LABS, Inc., San Jose, CA (US)

(72) Inventors: Jun Tao, Ladera Ranch, CA (US); Matthew Guo, San Jose, CA (US)

(21) Appl. No.: 16/544,509

(22) Filed: Aug. 19, 2019

(51) Int. Cl. G06F 11/10; G06F 11/07; G06F 3/06

(52) U.S. Cl. CPC G06F 11/1076; G06F 11/0793; G06F 3/0689; G06F 3/064; G06F 3/0619

(57) ABSTRACT

A storage system includes: a first storage plane configured to store multiple bits per cell; a second storage plane configured to store multiple bits per cell; a control processor, coupled to the first storage plane and the second storage plane, configured to: read user data including reading a first page type in the first storage plane and a second page type in the second storage plane, and detect an uncorrectable error in the user data; an error recovery (ER) circuitry, coupled to the control processor configured to correct the uncorrectable error in the user data by applying an XOR parity page to the user data; and a system interface, coupled to the ER circuitry, configured to transfer the user data after the uncorrectable error is corrected.

### TECHNICAL FIELD

An embodiment of the present invention relates generally to a storage system, and more particularly to a system for error recovery processing.

### BACKGROUND

As semiconductor technology advances and cell geometry shrinks, non-volatile memory, such as NAND flash, has driven massive increases in capacity. The shrinking geometry has increased the fragility of the individual cells and can adversely impact data retention and reliability.

Thus, a need still remains for a storage system with data reliability mechanism to provide improved data reliability and minimize read access times of the non-volatile memory devices. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF INVENTION

An embodiment of the present invention provides an apparatus, including a storage system includes: a first storage plane configured to store multiple bits per cell; a second storage plane configured to store multiple bits per cell; a control processor, coupled to the first storage plane and the second storage plane, configured to: read user data including reading a first page type in the first storage plane and a second page type in the second storage plane, and detect an uncorrectable error in the user data; an error recovery (ER) circuitry, coupled to the control processor configured to correct the uncorrectable error in the user data by applying an XOR parity page to the user data; and a system interface, coupled to the ER circuitry, configured to transfer the user data after the uncorrectable error is corrected.

An embodiment of the present invention provides a method including reading a first page type in the first storage plane and a second page type in the second storage plane; detecting an uncorrectable error in the user data; applying an XOR parity page to correct the uncorrectable error in the user data; and transferring the user data after the uncorrectable error is corrected.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a block diagram of a storage system with data reliability mechanism in an embodiment of the present invention.

FIG. 2 depicts a functional block diagram of a 1 and 0 counter in an embodiment.

FIG. 3 is a functional block diagram of an XOR engine in an embodiment.

FIG. 4 is a graphical view of an exemplary mapping of pages of the non-volatile memory array with the uncorrectable error.

FIG. 5 is an exemplary functional block diagram of the page type select logic in an embodiment of the present invention.

FIG. 6 is a flow chart of a method of operation of a storage system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include hardware or hardware supported by software in an embodiment of the present invention in accordance with the context in which the term is used. For example, the software can be machine code, firmware, embedded code, and application software. Also for example, the hardware can be circuitry, processor, computer, integrated circuit, integrated circuit cores, application specific integrated circuit (ASIC), passive devices, or a combination thereof. The term “plane” referred to herein can be defined as an integrated circuit memory device or a separately regulated portion of the integrated circuit memory device that can have multiple of the separately regulated portions.

As an example, one method to reduce the time spent in error recovery is to apply a read threshold mechanism to predict the optimum read threshold of a storage page and adjust it for the usable storage before the errors become unrecoverable.

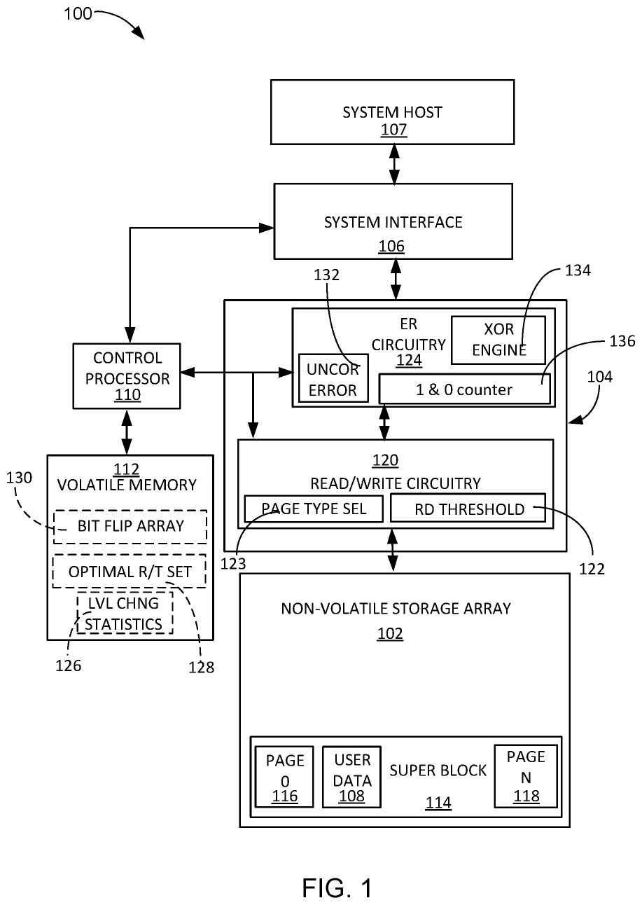

Referring now to FIG. 1, therein is shown a functional block diagram of a storage system 100 with data reliability mechanism in an embodiment of the present invention. The functional block diagram of the storage system 100 depicts a non-volatile memory array 102 coupled to a read/write channel 104. A system interface 106 transfers user data 108 to and from the non-volatile memory array 102. The system interface 106 can execute the movement of the user data 108 into and out of the storage system 100. As an example, the system interface 106 can transfer the user data 108 through the read/write channel 104 for storage to and retrieval from the non-volatile memory array 102.

The non-volatile memory array 102 can include multiple integrated circuit die, multiple planes within the multiple integrated circuit die, or a combination thereof, for the purpose of storing and accessing the user data 108 provided through the system interface 106. The non-volatile memory array 102 can include any number of non-volatile memory integrated circuits capable of storing multiple bits per cell, such as multi-level cell (MLC), triple-level cell (TLC), quad-level cell (QLC), or the like. The system interface 106 can communicate with a system host 107 through one or more interface protocols such as a universal serial bus (USB), a multi-media card (MMC), a peripheral component interconnect express (PCI-E), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The read/write channel 104 can be a hardware structure that can be supported by software, to encode and decode the user data 108 for storage in the non-volatile memory array 102. The read/write channel 104 can also generate error correction data and perform error correction of the user data 108 read from the non-volatile memory array 102. The user data 108 can be program data or input data stored in the non-volatile memory array 102 for later execution or processing.

A control processor 110 can provide at least a portion of the computation resource for the storage system 100. For example, the control processor 110 can be a processor, an application specific integrated circuit (ASIC), an embedded processor, a microprocessor, a hardware control logic, a hardware finite state machine (FSM), a digital signal processor (DSP), or a combination thereof. The control processor 110 can coordinate the operation of the storage system 100. As an example, the control processor 110 can be coupled to the system interface 106, the read/write channel 104, and a volatile memory 112.

The volatile memory 112 provides at least a portion of the storage of information for the storage system 100. As examples, the volatile memory 112 can be a volatile memory array, such as a matrix of interconnected volatile memory integrated circuits including dynamic random-access memory (DRAM), static random access memory (SRAM), register files, non-volatile memory, or a combination thereof, coupled to the control processor 110.

The system interface 106 can be supported by the control processor 110. The control processor 110 can be implemented with hardware circuitry in a number of different manners. The system interface 106 can be implemented as a hardware control logic, a hardware finite state machine (FSM), or a programmable bus controller, that can provide data transport between the non-volatile memory array 102 and the system host 107.

The system host 107 can be a computer, a processor, a processor core, a device controller, or a combination thereof configured to generate, store, and retrieve the user data 108. The system host 107 can be directly coupled to the system interface 106, or it can be attached through a local bus, a local area network (LAN), or wide area network (WAN).

The non-volatile memory array 102 can also include a remote resource, such as a NAND flash-based network attached storage (NAS), storage area network (SAN), or a combination thereof. The cells in the non-volatile memory array 102 are organized into a plurality of super blocks 114. Each of the super blocks 114 can contain data pages from page 0 116 through page N 118, with each of the page 0 116 through the page N 118 written on a separate integrated memory device or a plane in the integrated memory device. Where the page can be a read/write unit page, a physical page, a word line, or a physical block within an integrated memory device or a plane within the integrated memory device.

The read/write channel 104 can be a hardware structure that can be supported by software, to encode and decode the user data 108 for storage in the non-volatile memory array 102. A read/write circuitry 120 can manage the writing to the page 0 116 through the page N 118. During the reading of the user data 108, the read/write circuitry 120 can manipulate a read threshold 122 in order to adjust for errors detected by an error recovery (ER) circuitry 124. The read/write circuitry 120 can also include a page type select logic 123. The page type select logic 123 can be a hardware circuit that can be configured by the control processor 110 to sequentially address different page types in the non-volatile memory array 102. The control processor 110 can collect a count of the read data level changes as the read threshold 122 is changed. The control processor 110 can maintain the count of level change statistics 126 indicating that a bit flip in the user data 108 caused by a level change has occurred on any of the read thresholds 122, which can be stored in the volatile memory 112.

The control processor 110 can adjust the read threshold 122, of the page 0 116 through the page N 118, based on the read threshold mechanism of the level change statistics 126, such as the bit flip count or information indicating a change in the data level between adjacent values of the read threshold 122, in order to maintain the operational performance of the currently addressed page in the super block 114.

The control processor 110 can manage the operation of the read/write channel 104 including performing calculations, optimizing the read threshold 122, and execution of interface commands delivered from the system host 107. The control processor 110 can provide the level change statistics 126 when reading the user data 108. The ER circuitry 124 can be a hardware structure used to encode intended or targeted data for providing error protection, error detection, error correction, redundancy, or a combination thereof.

The ER circuitry 124 can include an XOR engine 134 that can generate the parity for multiple the page 0 116 through the page N 118. The XOR engine 134 can be a hardware matrix capable of generating RAID parity across multiple of the page 0 116 through the page N 118. During read processing the XOR engine 134 can regenerate data that is missing or corrupted from the page 0 116 through the page N 118 by applying the RAID error recovery. The ER circuitry 124 can also include a 1 and 0 counter 136. The 1 and 0 counter 136 can be a hardware structure that can monitor the state of the individual data bits of the selected one of the page 0 116 through the page N 118 while processing the read data. During the analysis of the read threshold 122, the control processor 110 can read the user data 108, without enabling the ER circuitry 124 to perform error correction on the data, in order to capture each instance of a level change in the user data 108. The control processor 110 can also read the output of the 1 and 0 counter 136 to determine whether the last read attempt provided a balanced number of 1's and 0's in the data pattern.

The read threshold 122 is defined as selectable voltage reference used when reading the stored value in the page 0 116 through the page N 118. The read threshold 122 can provide the voltage reference in incremental steps. By way of an example, the read threshold can have 128 linear steps that set the reference voltage for each of the design point voltage levels for the ideal read-back cell. The TLC NAND will have 7 major bit thresholds, {A, B, C, D, E, F, G}. The 128 steps available can be centered on each of the 7 major thresholds. This can be compared to QLC NAND, which has 15 major thresholds, and 128 steps applied to each.

The storage system 100 can generate an optimal read threshold set 128 by performing multiple reads of the user data 108 with stepped values of the read threshold 122. Between reads the read threshold 122 can be incremented and the resulting data compared. By detecting and logging the number of bits that change value on each incremental step, a bit flip array 130 can be constructed. The bit flip array can be a matrix of the number of level changes counted for each selected offset step count for each of the read threshold 122 {A, B, C, D, E, F, G}. The control processor 110 can search the bit flip array 130 for the offset values that represents the minimum number of changed bits for each of the read threshold 122 {A, B, C, D, E, F, G}. These offset values represent the optimal read threshold set 128, which can provide the best possibility of correctly reading the user data 108 without detecting an uncorrectable error 132. It is understood that the uncorrectable error 132 is a data error that contains too many bit errors for the ER circuitry 124 to correct the user data 108 without additional processing.

A large number of program and erase (P/E) cycles can cause the voltage of the cells holding the user data 108 to deviate from expected ranges after programming. Read disturbs, which refers to a significant amount of read operation on the page 0 116 through the page N 118 of the super block 114, will also cause the super block 114 to shift to a higher voltage range. Therefore, it is extremely critical to calculate the optimal read threshold set 128, which provide the smallest number of read errors.

As the page 0 116 through the page N 118 are repeatedly accessed, the voltage level of the user data 108 can shift making the valid settings for the read threshold 122 change over time. It is understood that the read threshold 122 can be adjusted dynamically based on the level change statistics 126 detected by the ER circuitry 124. The detection of the uncorrectable error 132 can cause the regeneration of the bit flip array 130 and selection of a new set of the optimal read threshold set 128 in order to better read the non-volatile memory array 102. In order to alleviate the additional number of reads required to correct the data read from and of the page 0 116 through the page N 118, the control processor 110 can monitor the 1 and 0 counter to determine whether there is a balance in the data pattern. If the 1 and 0 counter 136 indicates a balanced data set, the control processor 110 can forego the remainder of the read retries and initiate the XOR engine 134 to perform a RAID parity correction of the user data 108. The decision to forego the remainder of the read retries can prevent further shifting of the data stored in the page 0 116 through the page N 118.

For illustrative purposes, the storage system 100 will be described as utilizing the data reliability mechanism in storing and accessing information with multi-level NAND flash memory. The multi-level NAND flash memory can include MLC, TLC, QLC, or other Flash technologies that store more than one bit per cell.

It is understood that the embodiment discussed above is used to describe the invention and other embodiments are possible. Another possible embodiment can integrate the control processor 110, the read/write channel 104, the system interface 106, the non-volatile memory array 102, or a combination thereof into a single circuit.

It has been discovered that the control processor 110 can proactively map the optimal read threshold set 128 for the page 0 116 through the page N 118 in the super block 114. This can allow the ER circuitry 124 to calculate the level change statistics 126 for further monitoring the read reliability of the page 0 116 through the page N 118 and forego the remainder of the read retries as soon as the 1 and 0 counter 136 indicates a balanced data page has been read. The control processor 110 can then invoke the XOR engine 134 to perform the RAID parity correction of the user data 108 without performing additional reads of the page 0 116 through the page N 118 having the uncorrectable error 132.

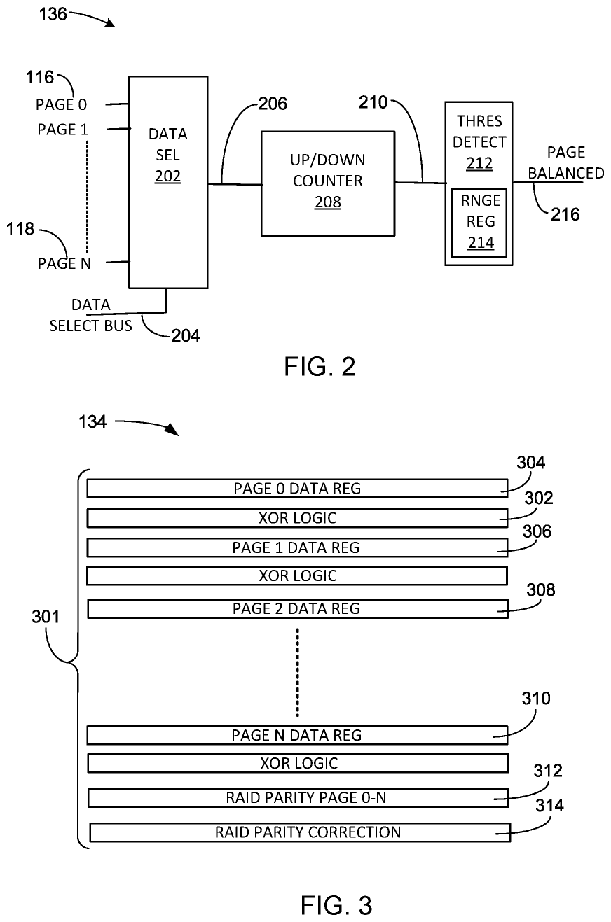

Referring now to FIG. 2, therein is a functional block diagram of the 1 and 0 counter 136 in an embodiment. The functional block diagram of the 1 and 0 counter 136 depicts the page 0 116 through the page N 118 coupled to a data selector 202. The data selector 202 can be a hardware multiplexer controlled by the control processor 110 of FIG. 1 through a data select bus 204. The data selector 202 can pass the user data 108 of FIG. 1 present on the input coupled to the page 0 116 through the page N 118 based on the address of the data select bus 204.

A selected channel data 206, output from the data selector 202, can be input to an up/down counter 208. The up/down counter 208 can be a hardware structure that can increment or decrement based on a data bit detected as a 1 or 0 respectively. It would be understood that a correctly read one of the page 0 116 through the page N 118 would result in the counter ending at a count of zero because there are the same number of 1's and 0's in the selected channel data 206. When the selected channel data 206 does not contain the same number of 1's and 0's, the up/down counter 208 will indicate a residual count 210 that is not equal to zero.

It is understood that the detection of the uncorrectable error 132 of FIG. 1 indicates that there are more error bits in the selected one of the page 0 116 through the page N 118 that can be corrected by the ER circuitry 124 of FIG. 1 performing error correction of the selected channel data 206 without additional information. During the error recovery process, the control processor 110 of FIG. 1 can adjust the read threshold 122 of FIG. 1 in order to increase the possibility of correcting the user data 108 presented on the selected channel data 206. In some cases, the adjustment of the read threshold 122 will not improve the likelihood of correcting the user data 108 presented on the selected channel data 206. In this event, other means must be employed to correct the user data 108.

The residual count 210 can be an indication that the read threshold 122 used to access the user data 108 might be corrected by the application of RAID parity when the control processor 110 invokes the XOR engine 134 of FIG. 1 without performing additional read retries of the uncorrectable error 132. The residual count 210 can be coupled to a threshold detector 212 that can verify the range of correction capabilities of the XOR engine 134. The threshold detector can be a hardware comparator with a range register 214 that is loaded by the control processor 110 to indicate the range of correction capabilities of the XOR engine 134. When the residual count 210, representing the difference in the count of 0's and the count of 1's, is less than or equal to the value contained in the range register 214, a page balanced 216 indicates the user data 108 can be corrected by the XOR engine 134 applying RAID parity to the page N 118 containing the uncorrectable error 132.

When the residual count 210 is greater than the value contained in the range register 214, the balanced page indicator is not set and the control processor 110 must continue to adjust the read threshold 122 in order to optimize the user data 108 that can be recovered by further read retries. The ability to detect when the read threshold 122 is close enough without being able to correctly read the selected one of the page 0 116 through the page N 118, can reduce the number of the read disturbs that are applied to the page 0 116 through the page N 118 that contains the uncorrectable error 132.

It has been discovered that the application of the 1 and 0 counter 136 can provide a shortened error recovery process and reduce the number of the read retries that are applied to the selected one of the page 0 116 through the page N 118 that contains the uncorrectable error 132. The resulting recovery process can improve the performance of the system host 107 of FIG. 1, while extending the useable life of the non-volatile memory array 102 of FIG. 1.

Referring now to FIG. 3, therein is shown a functional block diagram of an XOR engine in an embodiment. The functional block diagram of the XOR engine 134 depicts a register array 301. The register array 301 can be a hardware register file with interconnecting instances of XOR logic 302 coupling the individual bits of a page 0 data register 304, a page 1 data register 306, a page 2 data register 308, and a page N data register 310. The XOR logic 302 can be a hardware structure configurable to sample the contents of the page 0 data register 304, the page 1 data register 306, the page 2 data register 308, and the page N data register 310. The XOR logic 302 can be implemented to generate a RAID parity page 0-N 312 or load a stored version of the RAID parity page 0-N 312 in order to correct the uncorrectable error 132 of FIG. 1 loaded in the page 0 data register 304 through the page N data register 310.

The page 0 data register 304, the page 1 data register 306, the page 2 data register 308, and the page N data register 310 are each a hardware register file capable of loading the data contents of the page 0 116 of FIG. 1 through the page N 118 of FIG. 1 for verification of the user data 108 of FIG. 1. By way of an example, if the uncorrectable error 132 is detected in the page 2 data register 308, the XOR engine 134 can be configured to correct the errors by loading the stored version of the RAID parity page 0-N 312 and loading the page 0 data register 304, the page 1 data register 306, and the page N data register 310 with the previously written data. The XOR logic 302 can be configured sample the data bits of the page 0 data register 304 through the page N data register 310 and the RAID parity page 0-N 312 while excluding the contents of the page 2 data register 308 containing the uncorrectable error 132. The XOR engine 134 can reconstruct the corrected contents of the page 2 data register 308 without the uncorrectable error 132 and store the result in a RAID parity correction 314. The RAID parity correction 314 is a register configured to receive the result of the XOR engine 134 processing the uncorrectable error 132.

Since the control processor 110 can shorten the read recovery time and address the uncorrectable error 132 without performing read retries with all possibilities of the read threshold 122, the number of read disturbs can be reduced and the data reliability can be maintained. It is understood that the application of the XOR engine 134 can shorten the time required to address the uncorrectable error 132 as well as reduce the further damage to the data caused by repeatedly reading the page 2 data with all possible values of the read threshold 122.

It has been discovered that the application of the XOR engine 134 can reduce the recovery time of the uncorrectable error 132 as well as extend the useful life of the non-volatile memory array 102 of FIG. 1. The control processor 110 can configure the XOR engine to generate the RAID parity page 0-N 312 to be stored with the super block 114 of FIG. 1 or load the previously stored version of the RAID parity page 0-N 312 to correct the uncorrectable error 132 within one of the page 0 116 through the page N 118. By reducing the number of read retries performed on the page 0 116 through the page N 118, the user data 108 is subjected to less damage caused by shifting voltages. This can make a significant difference when the non-volatile memory array 102 is near the end of its useful life. The application of the XOR engine 134 over the entire life cycle of the non-volatile memory array 102 will significantly extend the life of the non-volatile memory array 102 and increase the performance of the storage system 100 of FIG. 1.

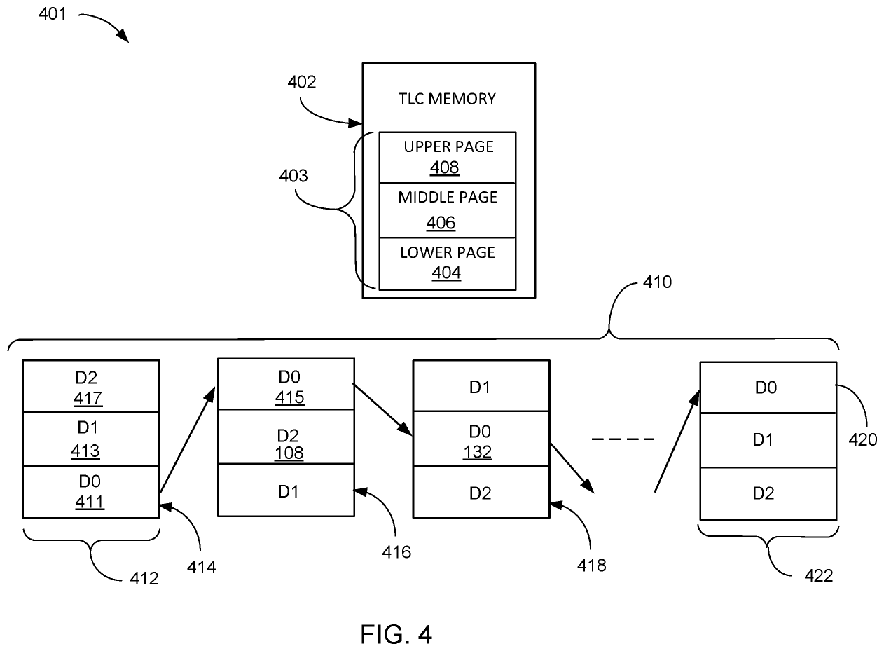

Referring now to FIG. 4, therein is shown a graphical view of an exemplary mapping 401 of pages of the non-volatile memory array 102 of FIG. 1 with the uncorrectable error 132 of FIG. 1. The graphical view of the exemplary mapping 401 of the non-volatile memory array 102 of FIG. 1 depicts a triple level cell (TLC) memory 402, capable of storing multiple bits per cell 403, including a lower page 404, a middle page 406, and an upper page 408. It is understood that the multiple bits per cell 403 is equal to three bits per cell in the TLC memory 402, but a multi-level cell (MLC) memory can store two bits per cell, and a quad-level cell (QLC) can store four bits per cell. By way of an example the non-volatile memory array 102 is shown having the TLC memory 402. It is understood that within the non-volatile memory array 102 the different page types can have different error rates.

It has been discovered that over time, the upper page 408 can have the lowest data reliability and the lower page 404 can have the highest data reliability. The middle page 406 can have the data reliability that falls somewhere between the lower page 404 and the upper page 408.

In order to counteract the disparity in data reliability between the lower page 404, the middle page 406, and the upper page 408, the read/write circuitry 120 can be configured by the control processor 110 to activate the page type select logic 123 of FIG. 1. The page type select logic 123 can address a different one of the lower page 404, the middle page 406, and the upper page 408 for each write of storage devices 412 in a super word line 410. The super word line 410 can include a number of the storage devices 412 each having one or more of a first storage plane 414 and each of the first storage plane 414 having only one of the lower page 404, the middle page 406, or the upper page 408 written with the user data 108 as controlled by the page type select logic 123. The storage devices 412 can include non-volatile memory devices capable of storing more that one bit per cell, for storing the user data 108.

By way of an example, the super word line 410 can include the user data 108 designated as D0, which can start in a first page type 411, such as the lower page 404, the middle page 406, or the upper page 408, of the first storage plane 414. The first storage plane 414 can be a physical plane within the first of the storage devices 412 available for storing or reading the user data 108. As shown in FIG. 4, the control processor 110 can assign another sequence of the user data 108, designated as D1 413, to be written to the super word line 410 starting in the middle page 406 of the first storage plane 414 and following a substantially similar pattern to the D0 pattern. Also, the control processor 110 can assign yet another sequence of the user data 108, designated as D2 417, to be written to the super word line 410 starting in the upper page 408 of the first storage plane 414 and following a substantially similar pattern to the D0 pattern. It is understood that the control processor 110 can assign the three sequences of the user data 108 written to the super word line 410 to be independent of each other and are mapped through each of the lower page 404, the middle page 406, or the upper page 408 in order to improve the probability of correcting the uncorrectable error 132 through the application of the corresponding one of an XOR parity page 420 in a RAID parity plane 422.

The user data 108 can be written to the upper page 408 in a second storage plane 416, and the middle page 406 in a third storage plane 418. It is understood that each of the user data 108 stored in the lower page 404, the middle page 406, or the upper page 408 includes an error correction code (not shown) to correct errors when the user data 108 is read back. The page type select logic 123 can perform a Modulo B shift for the next target page to be written or read, where the B represents the number of bits stored in the cell. As such, MLC FLASH uses a Modulo 2 shift, TLC FLASH uses a Modulo 3 shift, and a QLC FLASH uses a Modulo 4 shift, and so on.

In the example of the super word line 410, an uncorrectable error can be found in the middle page 406 of the third storage plane 418. In this event, the ER circuitry 124 of FIG. 1 can access the XOR parity page 420 in the RAID parity plane 422 in order to correct the user data 108 stored in the middle page 406 of the third storage plane 418, which can be identified as the D0 411 sequence. It is understood that the XOR parity page 420 is also mapped by the page type select logic 123. Since the page type select logic 123 increments through the super word line 410 as each page is written, the sequence of the data location can be resolved from any starting location when the uncorrectable error 132 is being processed by the ER circuitry 124 of FIG. 1 using the XOR engine 134 of FIG. 1 to generate the RAID parity correction 314 of FIG. 3.

It has been discovered that the storage system 100 of FIG. 1 can improve the ability to correctly read the user data 108 from the less reliable portions of the super word line 410 that are stored in the upper page 408. By mixing the types of pages between the lower page 404, the middle page 406, and the upper page 408, a higher probability exists to perform a data correction of the uncorrectable error 132. While each of the lower page 404, the middle page 406, and the upper page 408 can be corrected by the error correction code (ECC) stored in the page 0 116 of FIG. 1 through the page N 118 of FIG. 1 with the user data 108, the ER circuitry 124 can rely on the being able to correct the user data 108 that has been identified as the uncorrectable error 132 by using the RAID parity plane 422. Since these operations can be performed before performing a significant number of re-reads with different levels of the read threshold 122, an increase in performance and data reliability can be achieved. Also, since the number of the re-read operations is reduced, there is less likelihood of charge depletion in the cells and less read disturbs in the adjacent cells of the super word line 410.

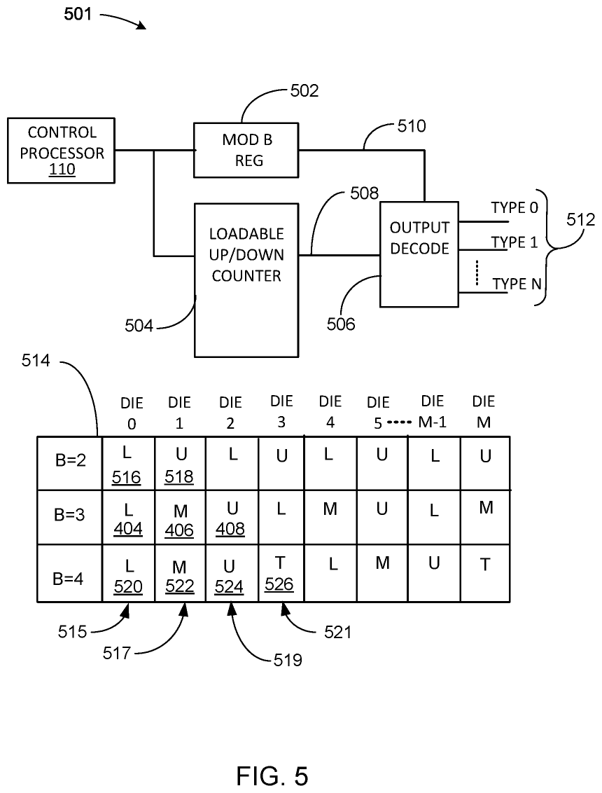

Referring now to FIG. 5, therein is shown an exemplary functional block diagram 501 of the page type select logic 123 in an embodiment of the present invention. The functional block diagram 501 depicts the control processor 110 coupled to a modulo B register 502 and a loadable up/down counter 504. The modulo B register 502 can be a register file loaded by the control processor 110 in order to limit the range of a page type selection. The loadable up/down counter 504 can be a counter chip or a register file manipulated by the control processor 110 in order to maintain the selection of the page type when writing or reading the storage devices 412 of FIG. 4.

The modulo B register 502 and the loadable up/down counter 504 can be coupled to an output decoder 506. The output decoder 506 can be a hardware logic structure that receives a count 508 from the loadable up/down counter 504 and a mode select 510 from the modulo B register 502 for determining page types 512. It is understood that the page types 512 can identify the page types 512 for various FLASH technologies. A usage table 514 depicts an example of possible mapping of the storage devices 412 based on the value of “B”. It is understood that the different values of B do not impact the operation of the storage system 100 of FIG. 1. Each of the storage devices 412 is written with only one of the page types 512.

The mode B=2 is used to support MLC FLASH and since there are two of the page types 512, the alternate pages will be written as a lower page 516 indicated by “L” in a first plane 515 and an upper page 518 indicated as “U” in a second plane 517. The mode where B=3 is shown in FIG. 4 and the pattern of rotating through the lower page 404 indicated by “L” in the first plane 515, the middle page 406 indicated by “M” in the second plane 517, and the upper page 408 indicated by “U” in a third plane 519. It is understood that the control processor 110 can start the writing of the user data 108 in any of the page types 512 without changing the shifting sequence based on the starting position. For the mode B=4 there are four of the page types 512. A lower page 520 indicated as “L” in the first plane 515, a middle page 522 indicated as “M” in the second plane 517, an upper page 524 indicated as “U” in the third plane 519, and the top page 526 indicated as “T” in a fourth plane 521. It is understood that the control processor 110 can initiate the write of the user data 108 of FIG. 1 in any of the available positions without having more than one of the page types 512 written per the storage devices 412 as indicated in the usage table 514.

By way of an example, the control processor 110 can write the user data 108 to the lower page 520, the middle page 522, the upper page 524, or the top page 526 in the first plane 515 without changing the shifting sequence, when the modulo B register 502 is set to four.

It has been discovered that the storage system 100 can increase performance and data reliability of the non-volatile memory array 102 when accessing the user data 108. The mapping of the of the storage devices 412 with one of the lower page 404, the middle page 406, or the upper page 408 can maximize the likelihood of correcting the uncorrectable error 132 of FIG. 1 when accessing the page 0 116 through the page N 118 of the super block 114. Any single occurrence of the uncorrectable error 132 can be addressed by applying the XOR RAID recovery 314 of FIG. 3 through the XOR engine 134.

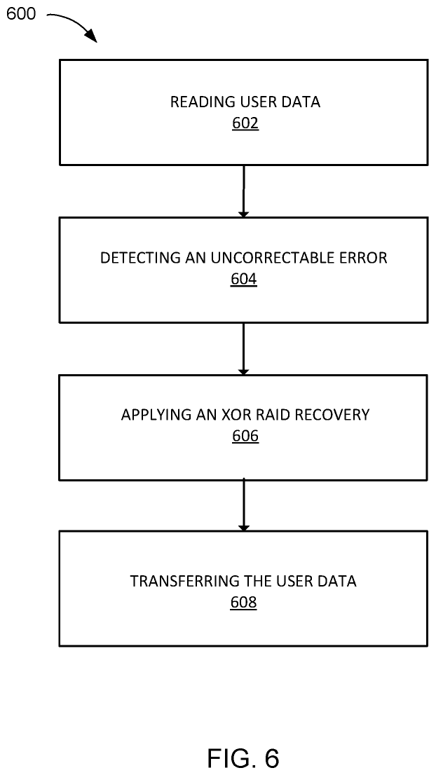

Referring now to FIG. 6, therein is shown a flow chart of a method 600 of operation of a storage system 100 in an embodiment of the present invention. The method 600 includes: reading a first page type in the first storage plane and a second page type in the second storage plane in a block 602; detecting an uncorrectable error in the user data, in a block 604; applying an XOR parity page to correct the uncorrectable error in the user data, in a block 606; and transferring the user data after the uncorrectable error is corrected in a block 608.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level. While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A storage system comprising:
a first storage plane configured to store multiple bits per cell;
a second storage plane configured to store the multiple bits per cell;
a control processor, coupled to the first storage plane and the second storage plane, configured to:
read user data including a first page type in the first storage plane and a second page type in the second storage plane, and
detect an uncorrectable error in the user data;
an error recovery (ER) circuitry, coupled to the control processor, configured to correct the uncorrectable error in the user data by applying an XOR parity page to the user data; and
a system interface, coupled to the ER circuitry, configured to transfer the user data after the uncorrectable error is corrected.

2. The system as claimed in claim 1 wherein the control processor is further configured to write the user data by writing the first page type to the first storage plane and the second page type to the second storage plane.

3. The system as claimed in claim 1 wherein the control processor is further configured to load a modulo B register for sequentially addressing one of the first page type or the second page type to a storage device by a page type select logic.

4. The system as claimed in claim 1 wherein the ER circuitry includes an XOR engine configured to perform a RAID parity correction including accessing the first storage plane, the second storage plane, and a RAID parity plane to correct the uncorrectable error.

5. The system as claimed in claim 1 wherein the control processor is further configured to start writing the user data in the first page type or the second page type by initializing a loadable up/down counter in a page type select logic.

6. The system as claimed in claim 1 wherein the control processor is configured to read the user data by accessing a lower page, a middle page, an upper page, or a top page in a first plane when a modulo B register is set to four.

7. The system as claimed in claim 1 wherein the control processor is configured to read the user data by accessing a lower page, a middle page, or an upper page in the first plane when a modulo B register is set to three.

8. The system as claimed in claim 1 wherein the control processor can configure the ER circuitry to load an XOR engine by reading one of the page type from the first plane into a page 0 data register and a next one of the page types into the next data register until a page N data register has been loaded, to generate a RAID parity correction.

9. The system as claimed in claim 1 wherein the control processor can increase the probability of correcting the uncorrectable error by mapping a different one of the page type to each of the storage devices.

10. The system as claimed in claim 1 wherein the control processor can follow a shifting sequence of the page type by loading the page type of the uncorrectable error and decrementing a loadable up/down counter to identify an initial page type.

11. A method of operation of a storage system comprising:
reading a first page type in the first storage plane and a second page type in the second storage plane;
detecting an uncorrectable error in user data;
applying an XOR parity page to correct the uncorrectable error in the user data; and
transferring the user data after the uncorrectable error is corrected.

12. The method as claimed in claim 11 further comprising writing the user data by writing the first page type to the first storage plane and the second page type to the second storage plane.

13. The method as claimed in claim 11 further comprising loading a modulo B register for sequentially address one of the first page type or the second page type to a storage device by a page type select logic.

14. The method as claimed in claim 11 further comprising performing a RAID parity correction including accessing a RAID parity plane for correcting the uncorrectable error.

15. The method as claimed in claim 11 further comprising writing the user data in the first page type or the second page type by initializing a loadable up/down counter in a page type select logic.

16. The method as claimed in claim 11 wherein reading the user data includes accessing a lower page, a middle page, an upper page, or a top page in the first plane when a modulo B register is set to four.

17. The method as claimed in claim 11 wherein reading the user data includes accessing a lower page, a middle page, or an upper page in the first plane when a modulo B register is set to three

18. The method as claimed in claim 11 further comprising loading an XOR engine by reading one of the page type from the first plane into a page 0 data register and a next one of the page types into the next data register until the page N data register has been loaded, to generate a RAID parity correction.

19. The method as claimed in claim 11 further comprising increasing the probability of correcting the uncorrectable error by mapping a different one of the page type to each of the storage devices.

20. The method as claimed in claim 11 further comprising following a shifting sequence of the page type includes loading the page type of the uncorrectable error and decrementing a loadable up/down counter to identify an initial page type.
